(19) United States
(12) Patent Application Publication
(10) Pub. No.: US 2018/0204377 A1
(43) Pub. Date: Jul. 19, 2018

(54) DISPLAY APPARATUS AND METHOD FOR IMAGE PROCESSING

(71) Applicant: SAMSUNG ELECTRONICS CO., LTD., Suwon-si (KR)

(72) Inventors: Eun-jung JU, Seoul (KR); Young-min KWAK, Suwon-si (KR); Min-hyo JUNG, Suwon-si (KR); Seong-oh LEE, Yongin-si (KR)

(73) Assignee: SAMSUNG ELECTRONICS CO., LTD., Suwon-si (KR)

(21) Appl. No.: 15/870,106

(22) Filed: Jan. 12, 2018

(30) Foreign Application Priority Data
Jan. 17, 2017 (KR) 10-2017-0008206

(51) Int. Cl. G06T 17/20; G06T 11/00; G06T 15/20; G06T 7/55

(52) U.S. Cl. CPC G06T 17/20; G06T 11/00; G06T 15/20; G06Q 30/0623; G06T 2207/10028; G06T 2207/20221; G06T 7/55

(57) ABSTRACT

An image processing method of a display apparatus. According to an embodiment the image processing method includes receiving image data for constructing a 3D image, dividing the 3D image into a plurality of objects based on the received image data and generating a 2D image with respect to each of the plurality of objects based on information on a viewpoint from which the 3D image is viewed, and synthesizing 2D images with respect to the plurality of objects based on distances between the viewpoint and the plurality of objects and displaying the synthesized 2D images.

### CROSS-REFERENCE TO RELATED APPLICATIONS

This application claims priority from Korean Patent Application No. 10-2017-0008206, filed on Jan. 17, 2017, in the Korean Intellectual Property Office, the disclosure of which is incorporated herein by reference in its entirety.

### BACKGROUND

### 1. Field of the Invention

Devices and methods consistent with what is disclosed herein relate to a display apparatus and a method for image processing, and more particularly, to a display apparatus for constructing a 2D image from a 3D image and a method for image processing.

### 2. Description of the Related Art

With the development of technology, a display apparatus provides an image of a user in an outfit that the user wishes to purchase or to wear to go out through a virtual fitting service.

Such the virtual fitting service is a technique of rendering the images of outfits and accessories selected by the user and the image of the user and providing a final image of the user wearing the selected outfits and accessories.

Accordingly, a user may check whether the outfits and accessories selected by him/her are good on him/her without trying on the outfits and accessories to purchase or to wear to go out beforehand through the virtual fitting service.

The user may select one of more kinds of outfits and accessories for purchasing or determining the style to go out.

In this case, the conventional virtual fitting service technique generates a final image by repeatedly rendering the images of the outfits and accessories selected by the user and the image of the user every time various kinds of outfits and accessories are selected by the user.

However, the conventional virtual fitting service technique has a problem of low-speed image processing by repeatedly rendering the images of outfits and accessories selected by a user and the image of the user every time various kinds of outfits and accessories are selected.

Therefore, the conventional virtual fitting service technique may not quickly provide a final image of the user wearing selected the outfits and accessories when various kinds of outfits and accessories are selected.

### SUMMARY

An aspect of the exemplary embodiments relates to providing a display apparatus capable of generating a high-speed 2D image from a 3D image of a person in a virtual outfit.

According to an exemplary embodiment, there is provided an image processing method of a display apparatus, the method may include receiving image data for constructing a 3D image, dividing the 3D image into a plurality of objects based on the received image data and generating a 2D image with respect to each of the plurality of objects based on information on a viewpoint from which the 3D image is viewed, and synthesizing 2D images with respect to the plurality of objects based on distances between the viewpoint and the plurality of objects and displaying the synthesized 2D images.

The image data may include at least one of mesh data for representing a 3D position of each of the plurality of objects, material information for generating an image of each of the plurality of objects and viewpoint information for representing the image of each of the plurality of objects in a 2D image.

A 2D image with respect to a first object among the plurality of objects may represent a person, and a 2D image with respect to a second object may represent an outfit.

The generating of the 2D image may include constructing a first 2D image with respect to a first object by using mesh data of the first object among the plurality of objects and the viewpoint information, and rendering the first 2D image by using material information of the first object.

The generating of the 2D image may further include constructing a second 2D image with respect to a second object by using mesh data of the second object among the plurality of objects and the viewpoint information, and rendering the second 2D image by using material information of the second object.

The displaying of the synthesized 2D images may include generating depth images respectively corresponding to the first and second 2D images based on the mesh data respectively corresponding to the first and second objects and the viewpoint information, selecting one of pixels constituting the first and second 2D images based on depth information for constructing the depth images respectively corresponding to the first and second 2D images, and generating the synthesized 2D images based on a color value of the selected pixel.

The selecting may include obtaining depth information of each pixel constituting the first and second 2D images, comparing the obtained depth information and selecting a pixel having a greater depth value.

The displaying of the synthesized 2D images may further include selecting one of a plurality of pixels constituting the first and second 2D images based on the mesh data respectively corresponding to the first and second objects and the viewpoint information, and generating the synthesized 2D images based on a color value of the selected pixel.

According to an exemplary embodiment, there is provided a display apparatus including a communicator configured to perform data communication with an external device and receive image data for constructing a 3D image, a display configured to display an image, and a controller configured to divide the 3D image into a plurality of objects based on the received image data and generate a 2D image with respect to each of the plurality of objects based on information on a viewpoint from which the 3D image is viewed, and synthesize 2D images with respect to the plurality of objects based on distances between the viewpoint and the plurality of objects and control the display to display the synthesized 2D images.

The image data may include at least one of mesh data for representing a 3D position of each of the plurality of objects, material information for generating an image of each of the plurality of objects and viewpoint information for representing the image of each of the plurality of objects in a 2D image.

A 2D image with respect to a first object among the plurality of objects may represent a person, and a 2D image with respect to a second object may represent an outfit.

The controller may be configured to construct a first 2D image with respect to a first object by using mesh data of the first object among the plurality of objects and the viewpoint information, and render the first 2D image by using material information of the first object.

The controller may be further configured to construct a second 2D image with respect to a second object by using mesh data of the second object among the plurality of objects and the viewpoint information, and render the second 2D image by using material information of the second object.

The controller may be further configured to generate depth images respectively corresponding to the first and second 2D images based on the mesh data respectively corresponding to the first and second objects and the viewpoint information, and select one of pixels constituting the first and second 2D images based on depth information for constructing the depth images respectively corresponding to the first and second 2D images and generate the synthesized 2D images based on a color value of the selected pixel.

The controller may be further configured to obtain depth information for each pixel constituting the first and second 2D images, compare the obtained depth information and select a pixel having a greater depth value.

The controller may be further configured to select one of a plurality of pixels constituting the first and second 2D images based on the mesh data respectively corresponding to the first and second objects and the viewpoint information and generate the synthesized 2D images based on a color value of the selected pixel.

According to an exemplary embodiment, there is provided a recording medium storing a program for executing an image processing method of a display apparatus, the method may include receiving image data for constructing a 3D image, dividing the 3D image into a plurality of objects based on the received image data and generating a 2D image with respect to each of the plurality of objects based on information on a viewpoint from which the 3D image is viewed, and synthesizing 2D images of the plurality of objects based on distances between the viewpoint and the plurality of objects and displaying the synthesized 2D images.

According to the present invention, a display apparatus may generate and provide a high-speed 2D image from a 3D image of a person in a virtual outfit.

### BRIEF DESCRIPTION OF THE DRAWINGS

FIG. 1 is an exemplary view illustrating an image processing of a display apparatus according to an embodiment of the present invention;

FIG. 2 is a block diagram illustrating a display apparatus according to an embodiment of the present invention;

FIG. 3 is a detailed block diagram illustrating a display apparatus according to an embodiment of the present invention;

FIG. 4 is an exemplary view provided to explain generating of respective 2D images of a plurality of objects constituting a 3D image in a display apparatus according to an embodiment of the present invention;

FIG. 5 is a first exemplary view provided to explain synthesizing of 2D images in a display apparatus according to an embodiment of the present invention;

FIG. 6 is a second exemplary view provided to explain synthesizing of 2D images in a display apparatus according to another embodiment of the present invention;

FIG. 7 is a flowchart provided to explain a method of image processing of a display apparatus according to an embodiment of the present invention;

FIG. 8 is a flowchart provided to explain generating of respective 2D images for a plurality of objects in a display apparatus according to an embodiment of the present invention;

FIG. 9 is a first flowchart provided to explain generating of a composite 2D image with respect to a 3D image in a display apparatus according to an embodiment of the present invention; and

FIG. 10 is a second flowchart provided to explain generating of a composite 2D image with respect to a 3D image in a display apparatus according to another embodiment of the present invention.

### DETAILED DESCRIPTION OF EXEMPLARY EMBODIMENTS

The terms used in this specification will be briefly described, and the present disclosure will be described in detail.

All the terms used in this specification including technical and scientific terms have the same meanings as would be generally understood by those skilled in the related art. However, these terms may vary depending on the intentions of the person skilled in the art, legal or technical interpretation, and the emergence of new technologies. In addition, some terms are arbitrarily selected by the applicant. These terms may be construed in the meaning defined herein and, unless otherwise specified, may be construed on the basis of the entire contents of this specification and common technical knowledge in the art.

In other words, the invention is not limited to an embodiment disclosed below and may be implemented in various forms and the scope of the invention is not limited to the following embodiments. In addition, all changes or modifications derived from the meaning and scope of the claims and their equivalents should be construed as being included within the scope of the present disclosure. In the following description, the configuration which is publicly known but irrelevant to the gist of the present disclosure could be omitted.

The terms such as “first,” “second,” and so on may be used to describe a variety of elements, but the elements should not be limited by these terms. The terms are used simply to distinguish one element from other elements.

The terms used in the application are merely used to describe particular exemplary embodiments, and are not intended to limit the invention. Singular forms in the invention are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

In an exemplary embodiment, ‘a module’, ‘a unit’, or ‘a part’ perform at least one function or operation, and may be realized as hardware, such as a processor or integrated circuit, software that is executed by a processor, or a combination thereof. In addition, a plurality of ‘modules’, a plurality of ‘units’, or a plurality of ‘parts’ may be integrated into at least one module and may be realized as at least one processor except for ‘modules’, ‘units’ or ‘parts’ that should be realized in a specific hardware.

When an element is referred to as being “connected” or “coupled” to another element, it can be electrically connected or coupled to the another element with one or more intervening elements interposed therebetween. In addition, when an element is referred to as “including” a component, this indicates that the element may further include another component instead of excluding another component unless there is different disclosure.

Hereinafter, embodiments will be described in greater detail with reference to the accompanying drawings. A thickness and spacing are presented for convenience of explanation, and could be exaggerated compared to an actual physical thickness. In the following description, the configuration which is publicly known but irrelevant to the gist of the present disclosure could be omitted. In addition, with regard to adding the reference numerals to constituent elements of each drawing, it should be noted that like reference numerals in the drawings denote like elements even though shown on the other drawings.

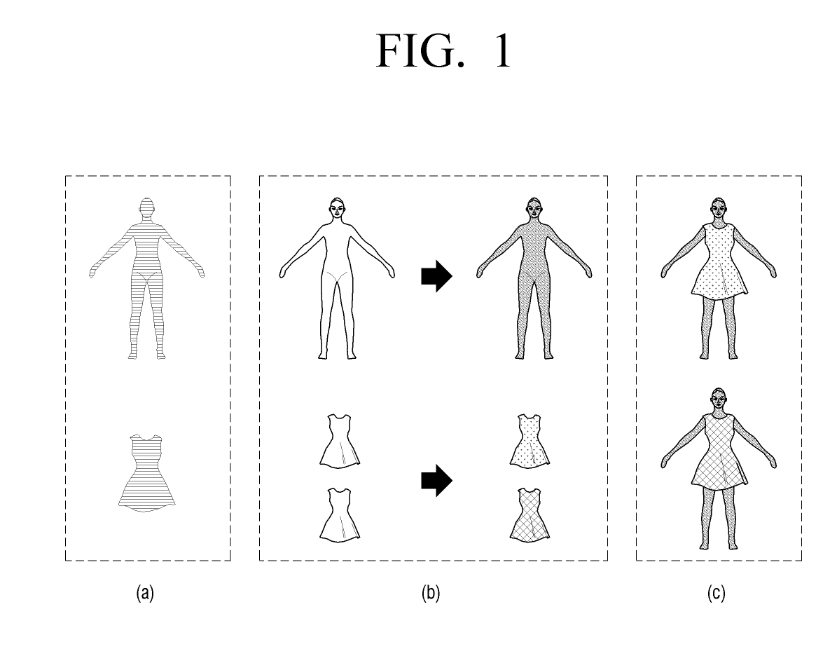

FIG. 1 is an exemplary view illustrating an image processing of a display apparatus according to an embodiment of the present invention.

As shown in FIG. 1, the display apparatus 100 may generate a 2D image of a person in a virtual outfit through the steps below.

Specifically, the display apparatus 100 may receive image data for constructing a 3D image from an external source at step (a).

The image data may include mesh data for representing a 3D position of each of a plurality of objects for constructing a 3D image, texture information for generating an image of each of the plurality of objects, material information including color information and light information and viewpoint information (e.g. position information, direction information and view angle information) from which the 3D image is viewed. It is preferable that the mesh data for representing the 3D position of each of the plurality of objects is matched with the material information for generating the image of each of the plurality of objects. In other words, it is preferable that the position information for representing the 3D position of each of the plurality of objects is matched with the color information.

In response to the image data being received, the display apparatus 100 may divide the 3D image into the plurality of objects that constitute the 3D image based on the image data received at step (b). As shown in FIG. 1, the display apparatus 100 may divide the 3D image into the plurality of objects that constitute the 3D image based on at least one of the mesh data and the material information included in the received image data. Specifically, the display apparatus 100 may distinguish a first object which is repeatedly rendered from a second object which is matched with the first object, among the plurality of objects. The first object may be an object for generating a 2D image related to an image of a person wearing an outfit, and the second object may be an object for generating a 2D image related to top and bottom outfits, accessories, etc. to go with the human image.

In response to the objects being separated by the first and second objects, the display apparatus 100 may generate respective 2D images of the first and second objects based on the viewpoint information and material information for each object included in the received image data.

Specifically, the display apparatus 100 may construct a first 2D image with respect to a first object by using mesh data of the first object and the viewpoint information and render the first 2D image by using material information of the first object.

The display apparatus 100 may generate a second 2D image with respect to a second object by using mesh data of the second object and the viewpoint information and render the second 2D image by using material information of the second object.

In response to the first and second 2D images with respect to the first and second objects being generated, the display apparatus 100 may output a final composite 2D image by synthesizing the first and second 2D images at step (c). Specifically, the display apparatus 100 may synthesize the first and second 2D images with respect to the first and second objects based on the viewpoint information and information of distances between the viewpoint and the first and second objects included in the image data.

For example, the image data with respect to the first object relating to the human image and the second object relating to the first and second outfits may be received. In such a case, the display apparatus 100 may generate 2D image data with respect to the first object relating to the human image and 2D image data with respect to the second object relating to the first and second outfits images based on the received image data.

In response to the 2D image data being generated, the display apparatus 100 may generate and output a final composite 2D image with respect to the first and second objects based on the viewpoint information and information of distances between the viewpoint and the plurality of objects included in the received image data.

Specifically, the display apparatus 100 may synthesize 2D images with respect to the human image and the first outfit image based on the viewpoint information and a distance information between the first object of the human image and the second object of the first outfit and output a composite of the 2D images. In addition, the display apparatus 100 may synthesize 2D images with respect to the human image and the second outfit image based on the viewpoint information and distance information between the first object of the human image and the second object of the second outfit and output a composite of the 2D images.

The display apparatus 100 according to an embodiment of the present invention may divide a 3D image into a plurality of objects constituting the 3D image based on the image data received from an external source, generate respective 2D images of the divided objects and synthesize the respective 2D images for objects based on the viewpoint and the distance information.

According to an embodiment, when generating 2D images of a plurality of objects constituting a 3D image, a time required for performing an image processing for generating respective 2D images of the objects may be reduced.

An operation of generating a 2D image of a person wearing a virtual outfit based on the received image data with respect to a 3D image in the display apparatus 100 according to an embodiment of the present invention is schematically described. Hereinafter, elements of the display apparatus 100 that generate the 2D image of the person wearing the virtual outfit based on the image data with respect to the 3D image according to the present invention will be described in detail.

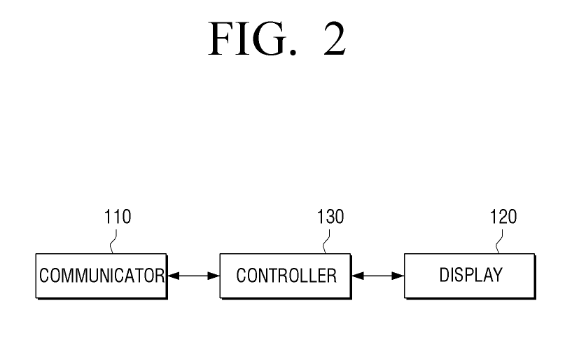

FIG. 2 is a block diagram illustrating a display apparatus according to an embodiment of the present invention.

Referring to FIG. 2, the display apparatus 100 may be a smart TV, a digital TV, a desk top PC, a kiosk, a large screen image output device, etc. Such the display apparatus 100 may include a communicator 110, a display 120 and a controller 130.

The communicator 110 may receive image data for constructing a 3D image by performing data communication with an external device (not shown). The external device (not shown) may be capable of performing communication with the display apparatus 100 and may be a device that provides contents data including a 3D image or a recording medium that provides contents data including a pre-stored 3D image by being physically connected to the display apparatus 100. In addition, the external device (not shown) may receive a user command and provide information related to 3D image generation corresponding to the input user command.

The image data may include at least one of mesh data for representing respective 3D positions of a plurality of objects that constitute a 3D image, material information for generating respective images of the objects and viewpoint information from which the 3D image is viewed.

The display 120 may display an image on a screen. Specifically, the display 120 may display a 2D image generated based on the image data for constructing the received 3D image on the screen. The 3D image may be an image of a person wearing an outfit, and the 2D image may be an image viewed from a viewpoint where the 3D image of the user wearing the outfits is viewed.

The controller 130 may control overall operations of elements that constitute the display apparatus 100. Specifically, the controller 130, in response to image data for constructing a 3D image being received from the external device (not shown) though the communicator 110, may divide the 3D image into a plurality of objects based on the received image data. The controller 130 may generate respective 2D images of the plurality of objects into which the 3D image is divided based on the viewpoint information included in the received image data.

The 2D image with respect to the first object among the respective 2D images of the objects into which the 3D image is divided may be a human image, which is repeatedly rendered, and the 2D image with respect to the second object may be an outfit image.

In response to respective 2D images with respect to the plurality of objects being generated, the controller 130 may synthesize the 2D images of the plurality of objects based on information of distances between the viewpoint and the plurality of objects and generate a final composite of the 2D images. The controller 130 may control the display 120 to display the final composite of the 2D images with respect to the plurality of objects. Accordingly, the display 120 may display the final composite of the 2D images of the plurality of objects on a screen.

Specifically, the controller 130 may construct a first 2D image with respect to the first object by using mesh data of the first object, among the plurality of objects, and the viewpoint information. The controller 130 may render the first 2D image with respect to the first object by using material information of the first object.

The controller 130 may construct a second 2D image with respect to the second object by using mesh data of the second object, among the plurality of objects, and the viewpoint information. The controller 130 may render the second 2D image with respect to the second object by using material information of the second object.

In response to the first and second 2D images with respect to the first and second objects being generated, the controller 130 may synthesize pre-generated first and second 2D images and generate a final composite of the 2D images according to an embodiment of the present invention.

According to an embodiment, the controller 130 may generate depth images respectively corresponding to the first and second objects based on the mesh data respectively corresponding to the first and second objects. The controller 130 may select one of pixels that constitute the first and second 2D images with respect to the first and second objects based on depth information constituting the depth images respectively corresponding to the first and second objects. According to an embodiment, the controller 130 may obtain depth information of each pixel constituting the first and second 2D images respectively corresponding to the first and second objects, compare the depth information for respective pixels and select a pixel having a greater depth value.

According to an embodiment, in response to one of the pixels constituting the first and second 2D images being selected, the controller 130 may generate a final composite of the 2D images based on a color value of the selected pixel.

According to another embodiment, the controller 130 may select one of a plurality of pixels constituting the first and second 2D image data respectively corresponding to the first and second objects based on the mesh data respectively corresponding to the first and second objects and the viewpoint information from which the 3D image is viewed. The controller 130 may generate a final composite of the 2D images based on a value of the selected pixel.

According to various embodiments of the present invention, in response to a final 2D image being generated, the display 120 may display a final 2D image into which the first and second 2D images with respect to the first and second objects are synthesized on the screen.

Hereinafter, the elements of the display apparatus 100 will be described in detail.

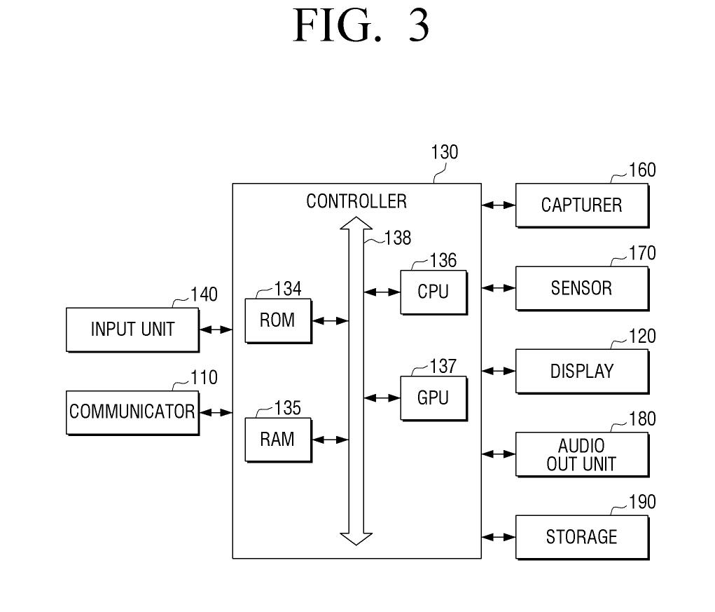

FIG. 3 is a detailed block diagram illustrating a display apparatus according to an embodiment of the present invention.

As described above, the display apparatus 100 may include a communicator 110, a display 120 and a controller 130. Referring to FIG. 3, the display apparatus 100 may further include an input unit 140, a capturer 160, a sensor 170, an audio output unit 180 and a storage 190.

The elements of the display apparatus 100 as shown in FIG. 3 are exemplified, but some of the elements of the electronic apparatus 100 shown in FIG. 3 may be omitted, modified or added depending on the type or purpose of the display apparatus 100.

The communicator may include a wireless communication module such as a short-distance communication module, a wireless LAN module, etc. and a wired communication module such as a High-Definition Multimedia Interface (HDMI), a Universal Serial Bus (USB), Institute of Electrical and Electronics Engineers (IEEE) 1394, and the like.

The short-distance communication module may be a module for performing wireless communication with an external device (not shown) providing image data for constructing a 3D image and a plurality of peripheral devices (not shown) registered to the display apparatus 100 and may include at least one of a Bluetooth module, an Infrared Data Association (IrDA) module, a Near Field Communication (NFC) module, a WIFI module, and a Zigbee module.

The wireless LAN module may be a module that is connected to an external network and performs communication according to a wireless communication protocol such as IEEE and may perform data communication with a web server (not shown), a content server (not shown), and the like.

In addition, the wireless communication module may further include a mobile communication module for performing communication by accessing a mobile communication network according to various mobile communication standards such as 3rd Generation (3G), 3rd Generation Partnership Project (3GPP) and Long Term Evolution (LTE), and the like.

As described above, the communicator 110 may be embodied by various short distance communication methods or may employ another communication technology, which is not mentioned in this application to the extent necessary.

The wired communication module may be a configuration for providing interfaces with various source devices such as USB 2.0, USB 3.0, HDMI, and IEEE 1394. The wired communication module may receive the content data transmitted from the external server (not shown) through a wired cable or transmit the stored content data to an external recording medium according to a control command of the processor 140 to be described below. In addition, the wired communication module may receive power from a power source via the wired cable.

The display 120 for displaying an image may be implemented as various types of displays such as a Liquid Crystal Display (LCD), an Organic Light Emitting Diode (OLED) display, and the like. A driving circuit and a backlight unit, which may be implemented in the form of a-si TFT, Low Temperature Poly Silicon (LTPS) TFT, organic TFT (OTFT), or the like, may also be included in the display 120. In addition, the display 120 may be implemented as a touch screen by being combined with a sensing sensor such as a touch sensor.

The input unit 140 may be a means for receiving various user commands and transmitting the received various user commands to the controller 130 and may include a microphone, an operator, a touch input, a user input unit, and the like.

The microphone may receive a voice command of a user, and the operator may be implemented by a key pad having various function keys, numeric keys, special keys, character keys, and the like. The touch input unit may be implemented as a touch pad forming a mutual layer structure with the display 120 described above. In this case, the touch input unit may receive a selection command for various application-related icons which are displayed on the display 120.

The user input unit may receive an IR signal or an RF signal for controlling an operation of the display apparatus 100 from at least one peripheral device (not shown) such as a remote controller.

The capturer 160 may include a lens (not shown) and an image sensor (not shown) and capture an image of an object at the request of a user.

The sensor 170 may be implemented as various sensing sensors for sensing a user command. For example, the sensor 170 may include a touch sensor. In addition, the sensor 170 may sense various information using various sensors. For example, the sensor 170 may sense motion information using a motion sensor (e.g., an acceleration sensor, a gyro sensor, a geomagnetic sensor, or the like).

The audio output unit 180 may output audio data of contents received from an external source in the form of audible tone. The storage 190, as described above, may store image data for constructing a 3D image, which is received from an external device (not shown). In addition, the storage 190 may further store respective 2D images with respect to a plurality of objects constituting the 3D image and the information relating to the 2D images. The storage 190 may further store an image processing module for generating the 2D images with respect to the plurality of objects constituting the 3D image based on the received image data.

Furthermore, the storage 190 may store an operation program for controlling an operation of the display apparatus 100. The operation program, if the display apparatus 100 is turned on, may be read in the storage 190 and compiled to operate each element of the display apparatus 100.

The controller 130 may further include a RAM 134, a ROM 135, a CPU 136, and a GPU 137, and the RAM 134, the ROM 135, the CPU 136 and the GPU 137 may be connected via a bus 138.

The CPU 136 may access the storage 190 and perform booting by using an operation system stored in the storage 190. The CPU 136 may perform various operations by using various programs, contents and data stored in the storage 190.

The GPU 137 may generate a display screen including various objects such as icons, images, contexts, etc. Specifically, the GPU 137 may calculate an attribute value such as a coordinate value, a shape, a size, a color, etc. for representing each object according to a layout of the screen based on the received control command and generate the display screen in various layouts including the objects based on the calculated attribute values.

The ROM 135 may store a command set, etc. for system booting. If a turned-on command is input and power is supplied, the CPU 136 may copy the operation system stored in the storage 190 to the RAM 134 according to the command stored in the ROM 135 and perform the system booting by executing the operation system. After completion of the system booting, the CPU 136 may copy the various programs stored in the storage 190 to the RAM 134, execute the program copied to the RAM 134 and perform various operations.

The controller 130 may be implemented as a system-on-a-chip (SOC) or a system-on-chip (SoC) in combination with each of the above-described elements.

The operation of the controller 130 may be performed by the program stored in the storage 190. The storage 190 may be embodied as one of the ROM 135, the RAM 134, a memory card (e.g., an SD card, a memory stick) detachable/attachable from/to the display apparatus 100, a non-volatile memory, a volatile memory, a Hard Disk Drive (HDD) or a Solid State Drive (SSD).

The elements of the display apparatus 100 according to the present invention have been described in detail.

Hereinafter, image processing of a plurality of objects constituting a 3D image based on image data for constructing the 3D image, which is received from the display apparatus 100 according to the present invention.

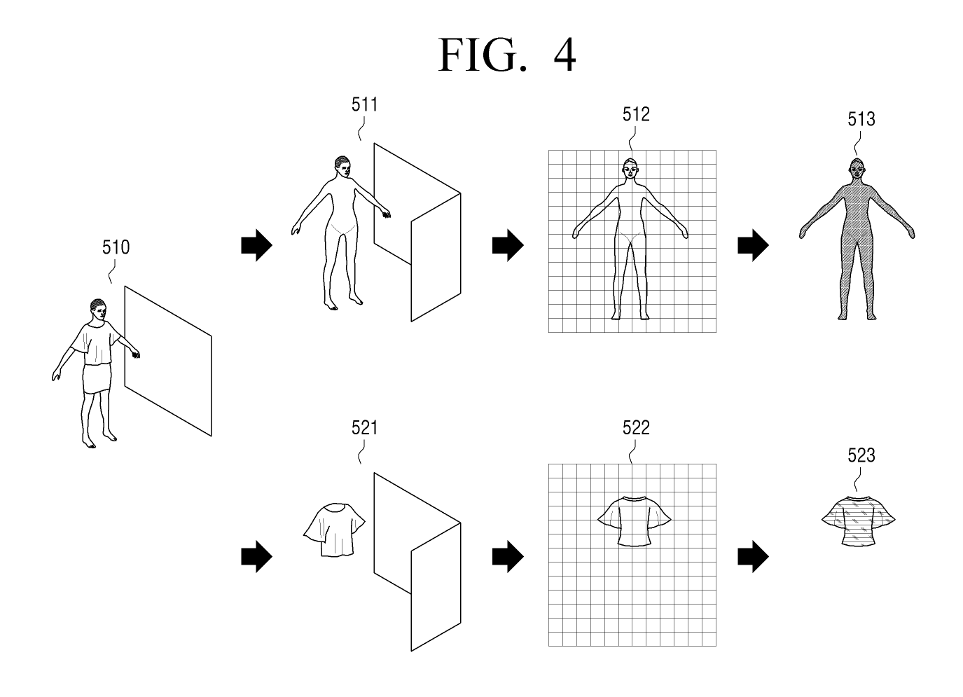

FIG. 4 is an exemplary view provided to explain generating of respective 2D images with respect to a plurality of objects constituting a 3D image in a display apparatus according to an embodiment of the present invention.

As shown in FIG. 4, the display apparatus 100 may, in response to image data for constructing a 3D image 510 being received, may divide the 3D image 510 into a plurality of objects based on the received image data. As shown in FIG. 4, the display apparatus 100 may divide the 3D image 510 into a first object 511 of a human image and a second object 521 of an outfit image based on the received image data.

In response to the 3D image 510 being separated into the first and second objects 511 and 521, the display apparatus 100 may generate 2D images with respect to the first and second objects 511 and 521 based on the viewpoint information and mesh data of the first and second objects 511 and 521 included in the received image data. As shown above, the display apparatus 100 may form a first 2D image 512 of a front view of a human image based on the viewpoint information and the mesh data with respect to the first object 511 included in the received image data. The display apparatus 100 may perform rendering of the first 2D image 512 of the front view of the human image based on material information of the first object 511. Accordingly, the display apparatus 100 may generate a first 2D image 513 in which a color relating to the human image is rendered.

The display apparatus 100 may generate a second 2D image 522 of a front view of an outfit image based on the viewpoint information and the mesh data with respect to the second object 521 included in the received image data. The display apparatus 100 may perform rendering of the second 2D image 522 of the front view of the outfit image based on material information of the second object 521. Accordingly, the display apparatus 100 may generate a second 2D image 523 in which a color relating to the outfit image is rendered.

The display apparatus 100 may divide the 3D image into a plurality of objects based on the received image data, perform rendering of each of the plurality of objects from a point of view and generate respective 2D images of the objects.

In response to the respective 2D images with respect to the objects being generated, the display apparatus 100 may store the respective 2D images with respect to the objects and color values of the pixels constituting each 2D image.

Hereinafter, an operation of the display apparatus 100 for generating a 2D image of a person in an outfit by synthesizing respective 2D images of a plurality of objects constituting a 3D image according to an embodiment of the present invention will be described in detail.

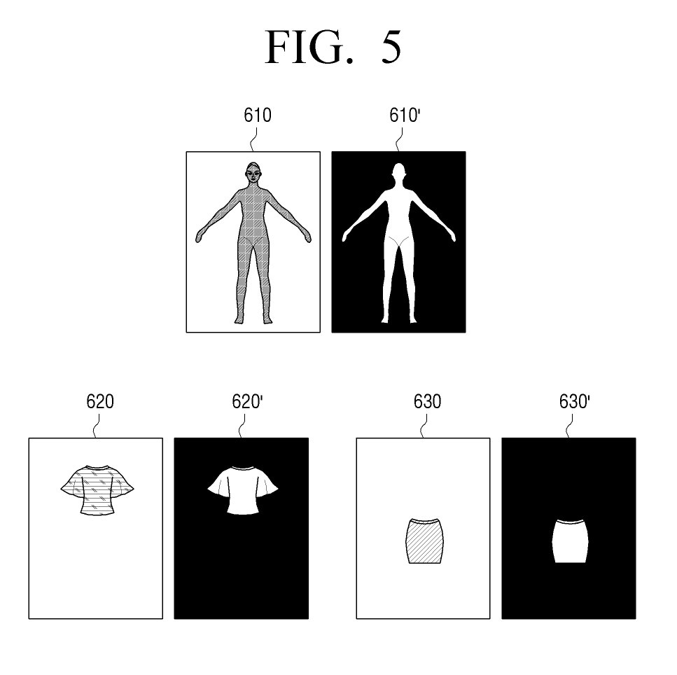

FIG. 5 is a first exemplary view provided to explain synthesizing of 2D images in a display apparatus according to an embodiment of the present invention.

As shown in FIG. 4, the display apparatus 100 may generate respective 2D images with respect to a plurality of objects based on mesh data for representing respective 3D positions of the plurality of objects constituting the 3D image, material information for generating respective images of the plurality of objects and viewpoint information from which the 3D image is viewed included the received image data.

Referring to FIG. 5, the display apparatus 100 may generate a first 2D image 610 with respect to a front view of a human image, a second 2D image 620 of a front view of a top outfit and a third 2D image of a front view of a bottom outfit based on the received image data.

The display apparatus 100 may generate respective depth images of the 2D images. Specifically, the display apparatus 100 may generate a depth image 610′ of the front view of the human image based on the viewpoint information and mesh data with respect to an object relating to the human image included in the received image data. In other words, the display apparatus 100 may determine an area closest to a first viewpoint on the basis of the first viewpoint as a depth information close to a white color and an area farthest away from the first viewpoint as a depth information close to a black color based on the viewpoint information and the mesh data with respect to the object relating to the human image. The display apparatus 100 may generate the depth image 610′ of a 2D image viewed from the front, which is the first viewpoint, based on the determined depth information for each area. Therefore, the display apparatus 100 may generate the first 2D image 610 and the depth image 610′ with regard to the human image.

The display apparatus 100 may generate a depth image 620′ of a front view of a top outfit image based on the viewpoint information and mesh data of the top outfit image object included in the received image data. In other words, the display apparatus 100 may determine an area closest to the first viewpoint on the basis of the first viewpoint as a depth information close to the white color and determine an area farthest away from the first viewpoint as a depth information close to the black color based on the viewpoint information and the mesh data of the top outfit image object. The display apparatus 100 may generate a depth image 620′ of a front view of a 2D image, which is viewed from the first viewpoint, based on the depth information determined for each area. Therefore, the display apparatus 100 may generate the second 2D image 620 with respect to the top outfit image and the depth image 620′.

The display apparatus 100 may generate a depth image 630′ of a front view of a bottom outfit image based on the viewpoint information and the mesh data with respect to the bottom outfit image object included in the received image data. In other words, the display apparatus 100 may determine an area closest to the first viewpoint on the basis of the first viewpoint as a depth information close to the white color and determine an area farthest away from the first viewpoint as a depth information close to the black color based on the viewpoint information and the mesh data of the bottom outfit image object. The display apparatus 100 may generate the depth image 630′ of a front view of a 2D image, which is viewed from the first viewpoint, based on the depth information determined for each area. Therefore, the display apparatus 100 may generate a second 2D image 630 with respect to the bottom outfit image and the depth image 630′.

In response to respective 2D images with respect to the plurality of objects and depth images respectively corresponding to the 2D images being generated, the display apparatus 100 may select one of pixels constituting each of the 2D images based on depth information constituting the depth images corresponding to the 2D images and generate a 2D image of a person wearing an outfit based on a color value of the selected pixel.

As described above, the depth image 610′ with respect to the human image, the depth image 620′ with respect to the top outfit image and the depth image 630′ with respect to the bottom outfit image may be generated. In response to the depth images 610′ to 630′ being generated, the display apparatus 100 may obtain depth information for each pixel, compare the obtained depth information and select a pixel having the greatest depth value. The display apparatus 100 may determine a color value applied to a pixel of the 2D image related to the selected pixel as a color value of the 2D images to be synthesized.

For example, a depth value of a first pixel of the depth image 620′ with respect to the top outfit image, among first pixels corresponding to the depth images 610′ to 630′, may have the greatest value. The display apparatus 100 may determine a color value of an area corresponding to a first pixel, among areas where the first 2D image 610 with respect to the human image and the second 2D images 620 and 630 with respect to the top and bottom outfit images are synthesized to be displayed, as a color value of a first pixel of the second 2D image 620 with respect to the top outfit image corresponding to the first pixel of the depth image 620′ with respect to the top outfit image.

The display apparatus 100 may determine a color value of the pixel for each area where the first 2D image 610 with respect to the human image and the second 2D images 620 and 630 with respect to the top and bottom outfit images are synthesized to be displayed, and generate a final 2D image based on the determined color value for each area.

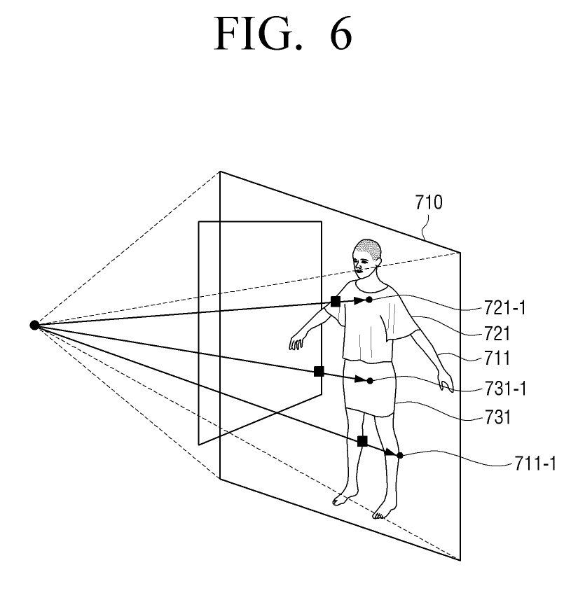

FIG. 6 is a second exemplary view provided to explain synthesizing of 2D images in a display apparatus according to another embodiment of the present invention.

The display apparatus 100 may select one of a plurality of pixels that constitute a 2D image with respect to each of a plurality of objects based on the viewpoint information from which a 3D image is viewed included and mesh data for representing a 3D position of each of the plurality of objects constituting the 3D image in the received image data and generate a final 2D image based on a color value applied to the selected pixel.

Referring to FIG. 6, the display apparatus 100 may determine a distance between areas for displaying the 2D images with respect to the 3D images (710) on the basis of the first viewpoint where the 3D image (710) is viewed from the front.

Specifically, the 3D image (710) may include a first object 711 with respect to a human image, a second object 721 with respect to a top outfit image and a third object 731 with respect to a bottom outfit image.

The display apparatus 100 may determine a color value for each area to be displayed by synthesizing 2D images with respect to the first, second and third objects 711 to 731 based on the viewpoint information and mesh data with respect to the first, second and third objects 711 to 731.

For example, a first area 721-1, among the areas where the 2D images with respect to the first to third objects 711 to 731 are synthesized to be displayed, may be closest to the second object 721 with respect to the top outfit image on the basis of the first viewpoint from which the 3D image (710) is viewed from the front. The display apparatus 100 may determine a color value of the pixel corresponding to the first area 721-1, among the pixels constituting the 2D image with respect to the top outfit image related to the second object 721, as a color value of the first area 721-1.

For example, a second area 731-1, among the areas where the 2D images with respect to the first to third objects 711 to 731 are synthesized to be displayed, may be closest to the second object 731 with respect to the bottom outfit image on the basis of the first viewpoint from which the 3D image (710) is viewed from the front. The display apparatus 100 may determine a color value of the pixel corresponding to the second area 731-1, among the pixels constituting the 2D image with respect to the bottom outfit image related to the second object 731, as a color value of the second area 731-1.

For example, a third area 711-1, among the areas where the 2D images with respect to the first to third objects 711 to 731 are synthesized to be displayed, may be closest to the first object 711 with respect to the human image on the basis of the first viewpoint from which the 3D image (710) is viewed straightforward. The display apparatus 100 may determine a color valued of the pixel corresponding to the third area 711-1, among the pixels constituting the 2D image with respect to the human image related to the first object 711 as a color value of the third area 711-1.

According to an embodiment, in response to a color value for each display area being determined, the display apparatus 100 may generate a final 2D image into which the 2D images with respect to the first to third objects 711 to 713 are synthesized based on the determined color value for each area and display the final 2D image on a screen.

An operation of generating a 2D image of a person in an outfit by synthesizing 2D images with respect to a plurality of objects constituting a 3D image has been described in detail. Hereinafter, an image processing method of the display apparatus 100 according to an embodiment will be described in detail.

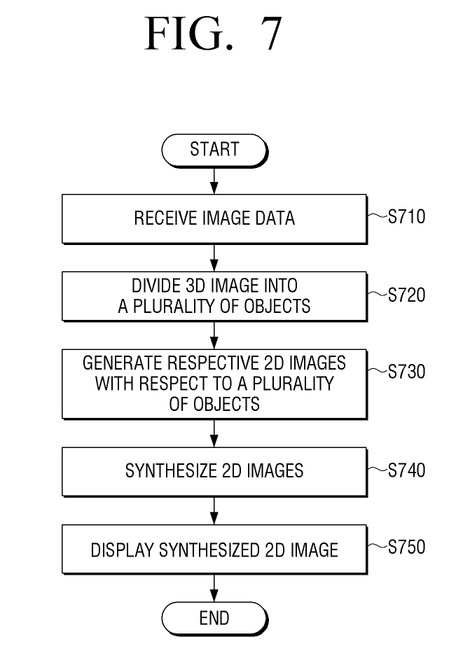

FIG. 7 is a flowchart provided to explain a method of image processing of a display apparatus according to an embodiment of the present invention.

Referring to FIG. 7, the display apparatus 100 may receive image data for constructing a 3D image from an external device (not shown) at step S710.

The image data for constructing the 3D image may include at least one of mesh data for representing a 3D position of each of a plurality of objects constituting the 3D image, material information for generating an image of each of the plurality of objects and viewpoint information from which the 3D image is viewed.

In response to the image data being received, the display apparatus 100 may divide the 3D image into the plurality of objects based on the received image data at step S720. The display apparatus 100 may generate respective 2D images with respect to the plurality of objects based on the viewpoint information from which the 3D image is viewed included in the received image data at step S730.

A 2D image with respect to a first object among the plurality of objects may represent a person and a 2D image with respect to a second object may represent an outfit.

In response to the respective 2D images with respect to the plurality of objects being generated, the display apparatus 100 may synthesize the respective 2D images with respect to the plurality of objects based on the viewpoint information from which the 3D image is viewed and distances between the viewpoint and the plurality of objects and generate the synthesized 2D image at step S740.

According to an embodiment, the display apparatus 100 may generate depth images respectively corresponding to first and second objects based on mesh data respectively corresponding to the first and second objects. The display apparatus 100 may select one of pixels constituting the first and second 2D images with respect to the first and second objects based on depth information constituting the depth images respectively corresponding to the first and second objects.

Specifically, the display apparatus 100 may obtain depth information for each pixel that constitutes the first and second images, compare the obtained depth information and select a pixel having a greatest depth value. The display apparatus 100 may generate a final 2D image with respect to the first and second images based on a color value of the selected pixel.

According to another embodiment, the display apparatus 100 may select one of a plurality of pixels that constitute the first and second images with respect to the first and second objects based on the mesh data respectively corresponding to the first and second object and the viewpoint information. The display apparatus 100 may generate a final 2D image with respect to the first and second 2D images based on a color value of the selected pixel.

Through such the embodiments, in response to the final 2D image with respect to the first and second images being generated, the display apparatus 100 may display the generated final 2D image on a screen at step S750.

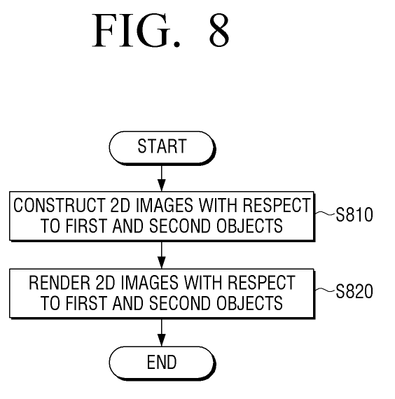

FIG. 8 is a flowchart provided to explain generating of respective 2D images with respect to a plurality of objects in a display apparatus according to an embodiment of the present invention.

Referring to FIG. 8, the display apparatus 100 may construct respective 2D images with respect to first and second objects based on the mesh data with respect to the first and second objects and the viewpoint information at step S810. The display apparatus 100 may render the respective 2D images with respect to the first and second objects based on material information with respect to the first and second objects at step S820.

Specifically, the display apparatus 100 may construct a first 2D image with respect to the first object based on the mesh data of the first object among the plurality of objects constituting the 3D image and the viewpoint information and render a first 2D image based on the material information of the first object.

The display apparatus 100 may construct a second 2D image with respect to the second object based on the mesh data of the second object and the viewpoint information and render a second 2D image based on the material information of the second object.

In response to the first and second 2D images with respect to the first and second objects being generated, the display apparatus 100 may output a final 2D image by synthesizing the first and second 2D images. Specifically, the display apparatus 100 may generate the 2D image into which the first and second 2D images with respect to the first and second objects are synthesized based on the viewpoint information and information of distances between the viewpoint and the first and second objects.

Hereinafter, a method for generating the 2D image into which the 2D images with respect to the plurality of objects constituting the 3D image are synthesized in the display apparatus 100 according to an embodiment will be described in detail.

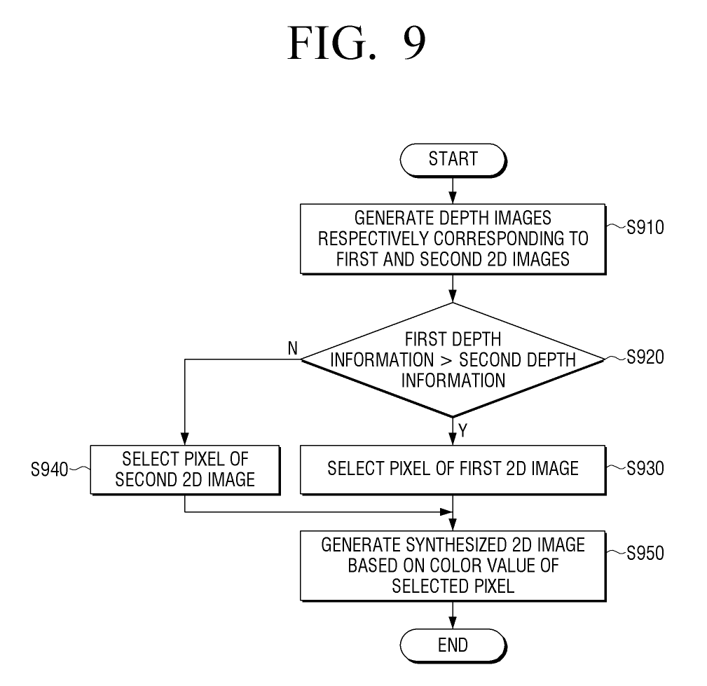

FIG. 9 is a first flowchart provided to explain generating of a composite 2D image with respect to a 3D image in a display apparatus according to an embodiment of the present invention.

Referring to FIG. 9, the display apparatus 100 may generate respective depth images corresponding to first and second objects based on the mesh data respectively corresponding to the first and second objects at step S910. The display apparatus 100 may compare depth information of pixels that constitute the depth images respectively corresponding to the first and second objects at step S920. Specifically, the display apparatus 100 may compare a first depth information for a pixel of the depth image corresponding to the first object with a second depth information for a pixel of the depth image corresponding to the second object.

As a result of comparison, if a depth value relating to the first depth information is greater than a depth value relating to the second depth information, the display apparatus 100 may select a pixel of the first 2D image with respect to the first object at step S930. If a depth value relating to the second depth information is greater than a depth value relating to the first depth information, the display apparatus 100 may select a pixel of the second 2D image with respect to the second object at step S940. The display apparatus 100 may generate the synthesized 2D image based on a color value of the pixel selected from the first and second images at step S950.

For example, the display apparatus 100 may compare a depth value of a first pixel among the pixels of the depth image corresponding to the first object with a depth value of a first pixel among the pixels of the depth image corresponding to the second object.

As a result of comparison, if the depth value of the first pixel of the depth image corresponding to the first object is greater, the display apparatus 100 may select the first pixel of the first 2D image with respect to the first object. The display apparatus 100 may determine a pixel value of an area corresponding to the predetermined first pixel among the areas onto where the 2D image synthesized from the first and second 2D images are displayed as a pixel value of the corresponding first pixel.

By repeatedly performing such the process, the display apparatus 100 may generate a composite 2D image of the first and second 2D images.

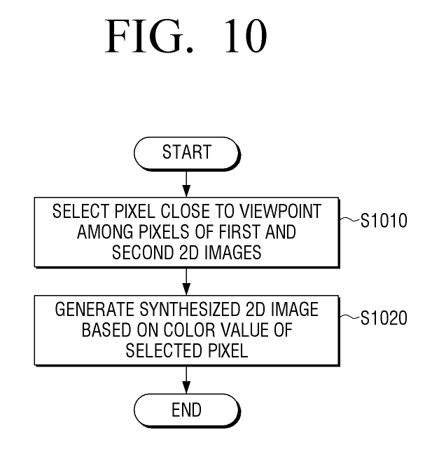

FIG. 10 is a second flowchart provided to explain generating of a composite 2D image with respect to a 3D image in a display apparatus according to another embodiment of the present invention.

Referring to FIG. 10, the display apparatus 100 may select a pixel close to an area corresponding to a viewpoint information, among the pixels constituting the first and second 2D images with respect to the first and second objects, based on the mesh data respectively corresponding to the first and second objects and the viewpoint information at step S1010. The display apparatus 100 may generate the 2D image into which the first and second 2D images are synthesized based on a color value of the selected pixel at step S1020.

For example, a first area, among the areas onto which a composite of the respective 2D images with respect to the first and second objects is displayed may be closest to the first object on the basis of the first viewpoint from which the 3D image is viewed from the front. In this case, the display apparatus 100 may determine a color value of the pixel corresponding to the first area, among the pixels constituting the first 2D image related to the first object as a color value of the first area.

According to an embodiment, in response to a color value for each display area being determined, the display apparatus 100 may generate a final 2D image into which the first and second images with respect to the first and second objects are synthesized based on the determined color value for each area.

The image processing method in the display apparatus 100 as described above may be implemented as at least one execution program, and the execution program may be stored in the non-transitory computer-readable medium

A non-transitory readable medium may be a medium that semi-permanently stores data and is readable by a device, not a medium a medium that stores data for a short period of time such as a register, a cache, a memory, etc. Specifically, the above-described program may be stored in a computer-readable recording medium such as a Random Access Memory (RAM), a flash memory, a Read Only Memory (ROM), an Erasable Programmable ROM (EPROM), an Electronically Erasable and Programmable ROM (EEPROM) Card, a register, a hard disk, a removable disk, a memory card, a USB memory, a CD-ROM, or the like.

The present invention has been described above with reference to preferred embodiments thereof.

Although exemplary embodiments have been shown and described, it will be appreciated by those skilled in the art that changes may be made to these exemplary embodiments without departing from the principles and spirit of the present disclosure. Accordingly, the scope of the present invention is not construed as being limited to the described exemplary embodiments, but is defined by the appended claims as well as equivalents thereto.

What is claimed is:

1. An image processing method of a display apparatus, the method comprising:
receiving image data for constructing a 3D image;
dividing the 3D image into a plurality of objects based on the received image data;
generating 2D images of respective objects, among the plurality of objects, based on the respective objects and viewpoint information, the viewpoint information indicating a viewpoint from which the 3D image is viewed;
synthesizing composite 2D images of the 2D images of the respective objects based on distances between the viewpoint and corresponding objects, of the respective objects; and
displaying the synthesized composite 2D images.

2. The method as claimed in claim 1, wherein the image data includes at least one of
mesh data for representing a 3D position of the plurality of objects, respectively,
material information for generating an image of the plurality of objects, respectively, and
viewpoint information for representing the image of the plurality of objects, respectively, in a 2D image.

3. The method as claimed in claim 1, wherein
a 2D image corresponding to a first object, among the plurality of objects, represents a person, and
a 2D image corresponding to a second object, among the plurality of objects, represents an outfit.

4. The method as claimed in claim 2, wherein the generating of the 2D images includes:
constructing a first 2D image corresponding to a first object, among the plurality of objects, by using mesh data of the first object and the viewpoint information, the mesh data of the first object being among the mesh data for representing the 3D position of the plurality of objects, respectively; and
rendering the first 2D image by using material information of the first object, the material information of the first object being among the material information for generating the image of the plurality of objects, respectively.

5. The method as claimed in claim 4, wherein the generating of the 2D image further comprises:
constructing a second 2D image corresponding to a second object, among the plurality of objects, by using mesh data of the second object and the viewpoint information, the mesh data of the second object being among the mesh data for representing the 3D position of the plurality of objects, respectively; and
rendering the second 2D image by using material information of the second object, the material information of the second object being among the material information for generating the image of the plurality of objects, respectively.

6. The method as claimed in claim 5, wherein the synthesizing of the synthesized composite 2D images includes:
generating depth images respectively corresponding to the first 2D image and the second 2D image based on the mesh data of the first object, the mesh data of the second object, and the viewpoint information;
selecting one pixel, among pixels constituting the first 2D image and the second 2D image, based on depth information for constructing the depth images respectively corresponding to the first 2D image and the second 2D image; and
generating the synthesized composite 2D images based on a color value of the selected pixel.

7. The method as claimed in claim 6, wherein the selecting the one pixel includes:
obtaining depth information of the pixels constituting the first 2D image and the second 2D image,
comparing the obtained depth information of the pixels, and
selecting a pixel having a greater depth value as selected pixel.

8. The method as claimed in claim 5, wherein the synthesizing of the synthesized composite 2D images further comprises:
selecting one pixel, among a plurality of pixels constituting the first 2D image and the second 2D image, based on the mesh data of the first object, the mesh data of the second object, and the viewpoint information; and
generating the synthesized composite 2D images based on a color value of the selected pixel.

9. A display apparatus, comprising:
a communicator configured to
perform data communication with an external device, and
receive image data for constructing a 3D image;
a display configured to display an image; and
a controller configured to:
divide the 3D image into a plurality of objects based on the received image data;
generate 2D images of respective objects, among the plurality of objects, based on the respective objects and viewpoint information, the viewpoint information indicating a viewpoint from which the 3D image is viewed;
synthesize composite 2D images of the 2D images of the respective objects based on distances between the viewpoint and corresponding objects, of the respective objects; and
control the display to display the synthesized composite 2D images.

10. The display apparatus as claimed in claim 9, wherein the image data includes at least one of
mesh data for representing a 3D position of the plurality of objects, respectively,
material information for generating an image of the plurality of objects, respectively, and
viewpoint information for representing the image of the plurality of objects, respectively, in a 2D image.

11. The display apparatus as claimed in claim 9, wherein
a 2D image corresponding to a first object, among the plurality of objects, represents a person, and
a 2D image corresponding to a second object, among the plurality of objects, represents an outfit.

12. The display apparatus as claimed in claim 10, wherein the controller is further configured to:
construct a first 2D image corresponding to a first object, among the plurality of objects, by using mesh data of the first object and the viewpoint information, the mesh data of the first object being among the mesh data for representing the 3D position of the plurality of objects, respectively, and
render the first 2D image by using material information of the first object, the material information of the first object being among the material information for generating the image of the plurality of objects, respectively.

13. The display apparatus as claimed in claim 12, wherein the controller is further configured to:
construct a second 2D image corresponding to a second object, among the plurality of objects, by using mesh data of the second object and the viewpoint information, the mesh data of the first object being among the mesh data for representing the 3D position of the plurality of objects, respectively, and
render the second 2D image by using material information of the second object, the material information of the second object being among the material information for generating the image of the plurality of objects, respectively.

14. The display apparatus as claimed in claim 13, wherein the controller is further configured to:
generate depth images respectively corresponding to the first 2D image and the second 2D image based on the mesh data of the first object, the mesh data of the second object, and the viewpoint information, and
select one pixel, among pixels constituting the first 2D image and the second 2D image, based on depth information for constructing the depth images respectively corresponding to the first 2D image and the second 2D image; and
generate the synthesized composite 2D images based on a color value of the selected pixel.

15. The display apparatus as claimed in claim 14, wherein the controller is further configured to
obtain depth information for the pixels constituting the first 2D image and the second 2D image,
compare the obtained depth information of the pixels, and
select a pixel having a greater depth value as selected pixel.

16. The display apparatus as claimed in claim 13, wherein the controller is further configured to
select one pixel, among a plurality of pixels constituting the first 2D image and the second 2D image, based on the mesh data of the first object, the mesh data of the second object, and the viewpoint information, and
generate the synthesized composite 2D images based on a color value of the selected pixel.

17. A non-transitory recording medium storing a program for executing an image processing method of a display apparatus, the image processing method comprising:
receiving image data for constructing a 3D image;
dividing the 3D image into a plurality of objects based on the received image data;
generating 2D images of respective objects, among the plurality of objects, based on the respective objects and viewpoint information, the viewpoint information indicating a viewpoint from which the 3D image is viewed;
synthesizing composite 2D images of the 2D images of the respective objects based on distances between the viewpoint and corresponding objects, of the respective objects; and
displaying the synthesized composite 2D images.
